(19) United States
(12) Patent Application Publication
(10) Pub. No.: US 2008/0198455 A1
(43) Pub. Date: Aug. 21, 2008

(54) Optical System, In Particular Objective Or Illumination System For A Microlithographic Projection Exposure Apparatus

(75) Inventors: Michael Totzeck, Schwaebisch Gmuend (DE); Daniel Kraehmer, Aalen (DE); Toralf Gruner, Aalen-Hofen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/813,902

(22) PCT Filed: Feb. 22, 2006
(86) PCT No.: PCT/EP2006/060196

§ 371 Date: Mar. 4, 2008

Related U.S. Application Data
(60) Provisional application No. 60/656,272, filed on Feb. 25, 2005.

(51) Int. Cl. G02B 27/18; G02B 27/28; G02B 1/08

(52) U.S. Cl. 359/499; 359/796

(57) ABSTRACT

The invention relates to an optical system, in particular an objective or an illumination system for a microlithographic projection exposure apparatus, which in particular also permits the use of crystal materials with a high refractive index while reducing the influence of intrinsic birefringence on the imaging properties. In particular the invention relates to an optical system having at least two lens groups (10-60) with lenses of intrinsically birefringent material, wherein the lens groups (10-60) respectively comprise a first subgroup with lenses in a (100)-orientation and a second subgroup with lenses in (111)-orientation, and wherein the lenses of each subgroup are arranged rotated relative to each other about their lens axes.

### BACKGROUND OF THE INVENTION

1. Field of the Invention

The invention relates to an optical system, in particular an objective or an illumination system for a microlithographic projection exposure apparatus. In particular the invention relates to an objective or an illumination system with one or more lenses of a material of high intrinsic birefringence.

2. State of the Art

For the purposes of reducing the adverse influence of intrinsic birefringence in fluoride crystal lenses on optical imaging it is known from US 2004/0105170 A1 and WO 02/093209 A2 inter alia to arrange fluoride crystal lenses of the same crystal cut in mutually rotated relationship (referred to as ‘clocking’), and additionally also to combine together a plurality of groups of such arrangements with different crystal cuts (for example of (100)-lenses and (111)-lenses).

That so-called ‘clocking’ of fluoride crystal lenses is based on the realisation that intrinsic birefringence produces a non-homogeneous distribution of the retardation caused across the pupil which is of a characteristic symmetry (threefold in the case of (111)-crystal and fourfold in the case of (100)-crystal). That pattern can be homogenised by a combination of mutually rotated lenses of the same cut, that is to say distribution becomes azimuthally symmetrical (in which case the azimuth angle a, specifies the angle between the beam direction projected into the crystal plane which is perpendicular to the lens axis and a reference direction which is fixedly linked to the lens). That configuration is referred to hereinafter as a ‘homogenous group’. The term ‘retardation’ is used to denote the difference in the optical paths of two orthogonal (mutually perpendicular) polarisation states. As in addition, particularly for example in the case of a homogeneous group comprising a (111)-crystal material and a homogeneous group of (100)-crystal material the fast axes of the retardation are perpendicular to each other, a combination of groups of (100)- and (111)-material involves further mutual compensation of the retardations arising out of the individual groups and thus a further reduction in the values obtained for the maximum retardation in birefringence distribution.

In present microlithographic objectives, in particular immersion lithography objectives with a value in respect of the numerical aperture (NA) of more than 1.0, there is increasingly a need for the use of materials with a high refractive index. The term ‘high’ is used to denote a refractive index if its value exceeds that of quartz, at a value of about 1.56 at a wavelength of 193 nm, at the given wavelength. Materials which are known hitherto and whose refractive index is greater than 1.6 at DUV and VUV wavelengths (<250 nm), are for example spinel with a refractive index of about 1.87 at a wavelength of 193 nm and YAG whose refractive index at that wavelength is probably 2.65. At 248 nm wavelength the refractive indices at 2.45 for spinel and 2.65 for YAG are also very high. The problem in regard to using those materials as lens elements is that they have intrinsic birefringence due to their cubic crystal structure, which for example for spinel has been measured to be at 52 nm/cm at a wavelength of 193 nm. The term ‘lenses’ is used here to denote all transparent optical components, that is to say also free form surfaces, aspherics and plane plates. It is generally to be expected that highly refractive crystals, in the DUV but in particular in the VUV wavelength range, also have high intrinsic birefringence which causes significant difficulties in regard to their use as a transparent optical element. That is all the more the case insofar as the high refractive index is advantageous in particular in the region near the image, for example in the last lens element. It is precisely there however that large beam angles occur in lithography objectives, and at those angles intrinsic birefringence is particularly high in the (100)- and (111)-crystal cut.

Further attempts to enable the use of highly refractive crystal materials while limiting the detrimental influence of intrinsic birefringence are disclosed in the non-published US-provisional application “Projektionsobjektiv einer mikrolithographischen Proiektionsbelichtungsanlage” filed on Dec. 23, 2005 and having the Ser. No. 60/753,715, the disclosure of which shall herewith be incorporated by reference in its entirety into the present application.

### SUMMARY OF THE INVENTION

It is an object of the present invention to provide an optical system, in particular an objective or an illumination system for a microlithographic projection exposure apparatus, which in particular also permits the use of crystal materials with a high refractive index while reducing the influence of intrinsic birefringence on the imaging properties.

The invention concerns in particular objectives with one or more lenses comprising a material with a high refractive index and high intrinsic birefringence (in particular with intrinsic birefringence of more than Δn=50 nm/cm), as in that case particular significance is attributed to reducing the retardation caused by the high intrinsic birefringence to avoid detrimental effects on the imaging properties.

In accordance with an aspect of the present invention an optical system, in particular an objective or an illumination system for a microlithographic projection exposure apparatus comprises at least one lens of a crystal material from the group which contains MgAl₂O₄, MgO and garnets, in particular Y₃Al₅O₁₂ (YAG) and Lu₃Al₅O₁₂ (LuAG), wherein at least two elements of said crystal material have the same crystal cut and are arranged rotated relative to each other about the lens axis, or there are two different crystal cuts of said crystal material, or both conditions are fulfilled (that is to say, in the latter case both at least two elements of said crystal material have the same crystal cut and are arranged rotated relative to each other about the lens axis and there are two different crystal cuts, in particular (100)- and (111)-crystal cuts, of said crystal material).

The term ‘elements’ in the sense used in the present application comprises the possibility that for example the at least two elements are seamlessly joined to each other or wringed together in order in that way to form a common lens.

In accordance with a further aspect of the present invention an optical system, in particular an objective or an illumination system for a microlithographic projection exposure apparatus comprises at least one lens of a crystal material from the group which contains NaCl, KCl, KJ, NaJ, RbJ and CsJ, wherein at least two elements of said crystal material have the same crystal cut and are arranged rotated relative to each other about the lens axis, or there are two different crystal cuts of said crystal material, or both conditions are fulfilled (that is to say, in the latter case both at least two elements of said crystal material have the same crystal cut and are arranged rotated relative to each other about the lens axis and there are two different crystal cuts, in particular (100)- and (111)-crystal cuts, of said crystal material).

In accordance with an embodiment the two elements are wringed together or seamlessly joined together so that they jointly form one lens.

In accordance with a further embodiment the two elements form two separate lenses.

In accordance with a further embodiment the combination of the two elements affords azimuthally symmetrical distribution of the retardation for two mutually perpendicular polarisation states.

In accordance with a further embodiment the combination of the two elements leads to a substantial reduction in the values of the retardation in comparison with a non-rotated arrangement or in comparison with the situation where there are only elements of the crystal material involving the same crystal cut. In that respect the expression ‘substantially reduced values’ is used to signify a distribution in respect of the retardation (in dependence on the aperture angle and the azimuth angle), at which the maximum value in terms of retardation distribution in comparison with a non-rotated arrangement or in comparison with the case where there are only elements of the crystal material involving the same crystal cut is reduced by at least 20%.

In accordance with a further embodiment the maximum beam angle occurring relative to the optical axis in the lens comprising said crystal material is not less than 25°, preferably not less than 30°.

It has been found that the compensation effect achieved by the foregoing clocking concept is not perfect and particularly in the case of strongly birefringent materials (with values of Δn of up to 100 nm/cm and above), a residual retardation which is significant in terms of the imaging properties occurs (by virtue of the intrinsic birefringence not being ideally compensated). In particular homogenous lens groups formed by combinations of mutually rotated lenses involving the same cut are admittedly homogeneous in respect of retardation distribution, that is to say azimuthally symmetrical, but not in regard to ellipticity of the eigenpolarizations, thereby resulting in a residual error in the reduction in retardation.

The invention therefore further pursues the aim of reducing that residual error in the reduction in retardation precisely when applied to strongly birefringent materials (involving values of Δn of up to 100 nm/cm and above). In that respect the invention makes use of the realisation that said residual error in the birefringence-induced retardation of the optical system rises not linearly but quadratically with increasing birefringence Δn or thickness d of the birefringent material (as will be described in greater detail hereinafter), so that upon a reduction for example in the thickness of individual, mutually rotated lenses, it is possible to achieve an overproportional reduction in the ‘residual error’.

Therefore, in accordance with a further aspect of the present invention, an optical system, in particular an objective or an illumination system for a microlithographic projection exposure apparatus, has at least two lens groups with lenses of intrinsically birefringent material, wherein the lens groups respectively comprise a first subgroup with lenses in a (100)-orientation and a second subgroup with lenses in a (111)-orientation, and wherein the lenses of each subgroup are arranged rotated relative to each other about their lens axes.

In that respect the term ‘lens group’ in the sense used in the present application in accordance with a preferred configuration is used to denote respective consecutive groups of lenses, in the sense that lenses belonging to a lens group are arranged in the optical system in succession or in mutually adjacent relationship along the optical axis.

In accordance with a preferred embodiment the lenses of each subgroup are arranged rotated relative to each other about their lens axes in such a way that each subgroup has an azimuthally symmetrical distribution of the retardation for two mutually perpendicular polarisation states.

In accordance with a further embodiment the lenses of each subgroup are rotated relative to each other about their lens axes in such a way that each subgroup has substantially reduced values in respect of retardation in comparison with a non-rotated arrangement of said lenses. In that respect the expression ‘substantially reduced values’ is used to denote a distribution in respect of retardation (in dependence on the aperture angle and the azimuth angle), at which the maximum value in terms of retardation distribution in relation to the maximum value in retardation distribution in the case of a non-rotated arrangement is reduced by at least 20%.

In accordance with a further embodiment the first subgroup has two (100)-lenses arranged rotated relative to each other about their lens axes through 45°+k*90° and the second subgroup has two (111)-lenses arranged rotated about their lens axes through 60°+l*120°, wherein k and l are integers.

In accordance with a preferred embodiment the (100)-lenses and the (111)-lenses of a lens group are arranged alternately relative to each other.

In accordance with a preferred embodiment the lenses of one of the lens groups are arranged rotated about their lens axes with respect to the lenses of another of the lens groups.

In accordance with a preferred embodiment respective lenses of a subgroup of a lens group are of a maximum thickness Dᵢ (i=1, 2, . . . ) and are made from a material with an intrinsic birefringence Δnᵢ and the lenses of a subgroup of another lens group are of a maximum thickness Dⱼ (j=1, 2, . . . ) and are made from a material with an intrinsic birefringence Δnⱼ so that the condition Δnᵢ*Dᵢ=Δnⱼ*Dⱼ is fulfilled in pairs for each two lenses. Preferably the condition Dᵢ, Dⱼ≦30 mm, preferably Dᵢ, Dⱼ−20 mm and still more preferably Dᵢ, Dⱼ≦10 mm, is fulfilled for the maximum thicknesses Dᵢ and Dⱼ.

In accordance with a preferred embodiment the number of lens groups is at least three and still more preferably at least four.

In accordance with a preferred embodiment the intrinsic birefringence of the material of at least one of the lenses is at least Δn=50 nm/cm, preferably at least Δn=75 nm/cm, still more preferably at least Δn=100 nm/cm.

In accordance with a preferred embodiment the lenses at least partially comprise a crystal material involving a cubic structure.

In accordance with a preferred embodiment the optical system has at least one lens comprising a crystal material from the group which contains MgAl₂O₄, MgO and garnets, in particular Y₃Al₅O₁₂ and Lu₃Al₅O₁₂.

In accordance with a further preferred embodiment the optical system has at least one lens comprising a crystal material from the group which contains NaCl, KCl, KJ, NaJ, RbJ and CsJ.

In accordance with a preferred embodiment the optical system has an image-side numerical aperture (NA) of at least 0.8, preferably at least 1.0, still more preferably at least 1.2 and still more preferably at least 1.4.

In accordance with a preferred embodiment the resulting maximum retardation of a beam at a working wavelength λ is less than λ/10.

In accordance with a further aspect the invention relates to an optical system, in particular an objective or illumination system for a microlithographic projection exposure apparatus, comprising at least one optical element of crystalline material which has an refractive index of at least 1.8, wherein the resulting maximum retardation at a working wavelength λ is less than λ/10. In particular, said crystalline material may be a cubically crystalline material.

In accordance with a further aspect the invention relates to an optical system, in particular an objective or illumination system for a microlithographic projection exposure apparatus, comprising at least one optical element of cubically crystalline material which has an intrinsic birefringence of at least Δn=50 nm/cm and a maximum beam path of at least 1 cm, wherein the resulting maximum retardation at a working wavelength λ is less than λ/10.

In accordance with a further aspect the invention relates to an optical system, in particular an objective or illumination system for a microlithographic projection exposure apparatus, wherein a beam path of at least 1 cm extends through an optical element of cubically crystalline material which has an intrinsic birefringence of at least Δn=50 nm/cm, wherein at least two lenses are arranged rotated relative to each other about their lens axes.

The invention also relates to a microlithographic projection exposure apparatus having an objective according to the invention, and also a microlithographic projection exposure apparatus having an illumination system according to the invention.

Further configurations of the invention are set forth in the description hereinafter and the appendant claims. The invention is described in greater detail hereinafter by means of embodiments by way of example illustrated in the accompanying drawings.

### BRIEF DESCRIPTION OF THE DRAWINGS

In the drawings:

FIG. 1 is a diagrammatic view of a lens arrangement for an optical system in accordance with an embodiment of the present invention;

FIG. 2 is a diagrammatic view of a lens arrangement for an optical system in accordance with a further embodiment of the present invention;

FIG. 3 shows a graph plotting the retardation (in units of nm) as a function of birefringence (in units of nm/cm) for increasing subdivision of the lenses or plates;

FIG. 4 shows the distribution of retardation across the pupil for a succession of two lens groups with an orientation which is the same relative to each other (FIG. 4a and FIG. 4c) or with an orientation which is rotated through 90° relative to each other (FIG. 4b);

FIGS. 5-6 show the distribution of retardation over the pupil for a lens group comprising two (111)-lenses and two (100)-lenses in a non-permutated arrangement (FIGS. 5a,c and 6a,c) and in a permutated arrangement (FIGS. 5b,d and 6b,d) respectively;

FIG. 7 shows for a lens group comprising two (111)-lenses and two (100)-lenses the dependency of retardation (in units of nm) on birefringence Δn (in units of nm/cm);

FIG. 8 shows the ellipticity of the eigenpolarizations of homogenised lens pairs in the 100-crystal cut (FIG. 8a) and the 111-crystal cut (FIG. 8b) respectively; and

FIG. 9 shows a diagrammatic view of a microlithographic projection exposure apparatus having an illumination system and a projection objective in which one or more lenses or lens arrangements according to the invention can be used.

### DETAILED DESCRIPTION OF PREFERRED EMBODIMENTS

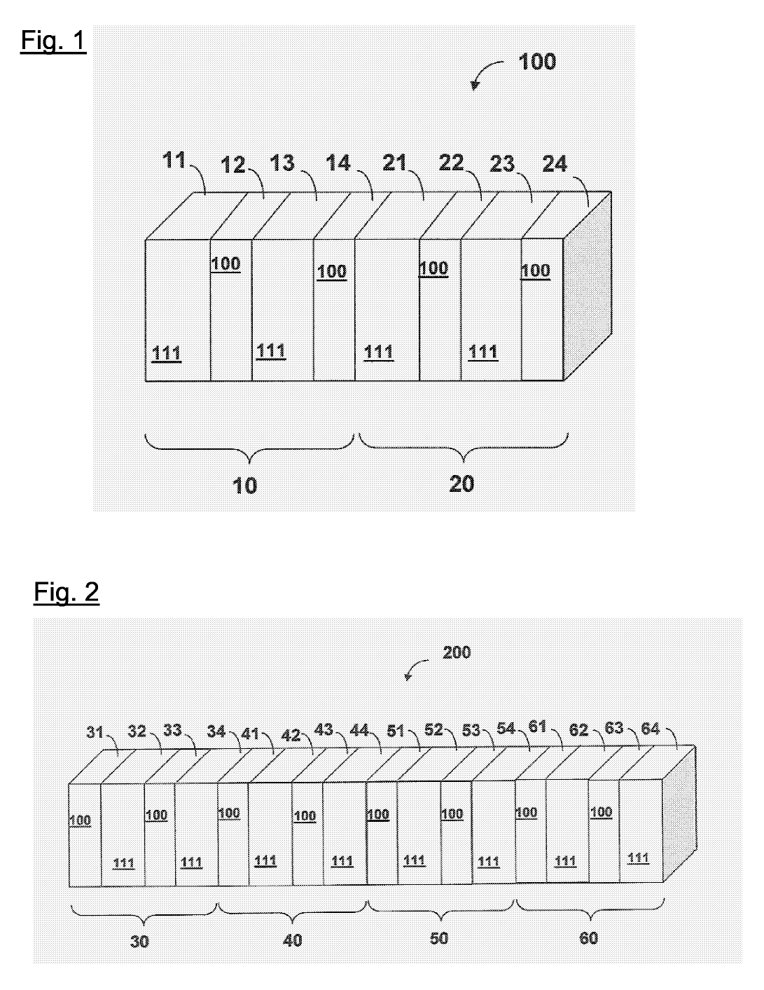

Referring to FIG. 1, a lens arrangement 100 for an optical system in accordance with an embodiment of the present invention has a first lens group 10 which is composed of lenses 11-14 and a second lens group 20 which is composed of lenses 21-24.

The lenses are at least partially produced from a cubically crystalline material of high intrinsic birefringence. Preferably the birefringence of the material of the lenses is at least Δn=50 nm/cm, preferably at least Δn=75 nm/cm, still more preferably at least Δn=100 nm/cm.

In that respect the value of the birefringence Δn specifies for a beam direction (which is defined by the aperture angle θ_{L} and the azimuth angle α_{L}) the ratio of the optical travel difference for two mutually orthogonal linear polarisation states relative to the physical beam path covered in the crystal [nm/cm]. The value of intrinsic birefringence Δn is thus independent of the beam paths and the lens form. The optical travel difference (referred to herein as the ‘retardation’) for a beam is accordingly obtained by multiplication of the birefringence by the beam path covered.

In this case the lenses 11 and 13 form a first subgroup of the lens group 10 and the lenses 12 and 14 form a second subgroup of the lens group 10. The lenses 11 and 13 of the first subgroup are respectively oriented in the (111)-direction and are rotated relative to each other about their lens axes through an angle of 60°. The lenses 12 ands 14 of the second subgroup are respectively oriented in the (100)-direction and are rotated relative to each other about their lens axes through an angle of 45°.

Those lenses in which the lens axes are perpendicular to the {100}-crystal planes (or the crystal planes which are equivalent thereto by virtue of the symmetry properties of the cubic crystals) are referred to as (100)-lenses. Correspondingly, those lenses in which the lens axes are perpendicular to the {111}-crystal planes or the crystal planes equivalent thereto are referred to as (111)-lenses.

Both the first and second subgroups in themselves, and also consequently the entire lens group 10, respectively form homogeneous groups with a distribution in respect of retardation, which is azimuthally symmetrical across the pupil, in which case in addition, in each subgroup, as a consequence of the rotation of the identically oriented lenses 11 and 13, 12 and 14 respectively relative to each other, the distribution of the retardation which is caused by intrinsic birefringence is of reduced values in comparison with a non-rotated arrangement.

As in addition the fast axes of the retardation are in mutually perpendicular relationship in respect of the lenses 11 and 13 in the (111)- orientation and in respect of the lenses 12 and 14 in the (100)-orientation, a combination of the two subgroups comprising the lenses 11, 13 and the lenses 12, 14 to afford the lens group 10 provides for mutual compensation of the two retardations and a reduction in the values obtained for the maximum retardation in birefringence distribution.

The second lens group 20 of the lens arrangement 100 is of the same structure as the first lens group 10. Accordingly the lenses 21 and 23 form a first subgroup of the lens group 20 and the lenses 22 and 24 form a second subgroup of the lens group 20. The lenses 21 and 23 of the first subgroup are respectively oriented in the (111)-direction and are rotated relative to each other about their lens axes through an angle of 60°. The lenses 22 and 24 of the second subgroup are respectively oriented in the (100)-direction and are rotated relative to each other about their lens axes through an angle of 45°.

Referring to FIG. 2 a lens arrangement 200 for an optical system in accordance with a further embodiment of the present invention has a first lens group 30 which is composed of lenses 31-34, a second lens group 40 which is composed of lenses 41-44, a third lens group 50 which is composed of lenses 51-54 and a fourth lens group 60 which is composed of lenses 61-64. In this arrangement the lenses 31 and 33 form a first subgroup of the lens group 30 and the lenses 32 and 34 form a second subgroup of the lens group 30. The lenses 31 and 33 of the first subgroup are respectively oriented in the (111)-direction and are rotated relative to each other about their lens axes through an angle of 60°. The lenses 32 and 34 of the second subgroup are respectively oriented in the (100)-direction and are rotated relative to each other about their lens axes through an angle of 45°. The second to fourth lens groups 40-60 of the lens arrangement 200 are of the same structure as the first lens group 30.

The two or more lens groups 10, 20, . . . have in themselves a retardation distribution which is both homogeneous and also reduced in respect of the maximum values. In accordance with the invention that is achieved by suitable rotation of the identically oriented lenses relative to each other and also by the above-indicated combination of the (100)-lenses with (111)-lenses within each lens group.

The structure of the lens groups 100 and 200 respectively shown in the embodiments of FIG. 1 and FIG. 2 now affords the further advantage that the ‘successive connection’ of the two or more lens groups 10, 20, . . . (which in themselves already involve a retardation distribution which is both homogeneous and also reduced in respect of the maximum values) affords a further reduction in the maximum values or a reduced distribution in retardation, more specifically in comparison with an arrangement having only one lens group of the same overall thickness of the arrangement (that is to say for example a single lens group involving the structure of the lens group 10, which is then made up of lenses of greater (in particular double) thickness.

In other words, in the embodiments of FIG. 1 and FIG. 2, a lens group with a distribution in respect of retardation which is already reduced in its maximum values (by constructing it for example from two (100)-lenses which are rotated relative to each other about their lens axes and two (111)-lenses which are rotated relative to each other about their lens axes, that is to say a combination of a total of four lenses for the purposes of forming homogeneous groups with a retardation distribution which is reduced in the maximum values involved) is further ‘subdivided’. In accordance with the embodiments of FIG. 1 and FIG. 2 that subdivision is effected into two or four such lens groups each comprising two (100)-lenses rotated relative to each other about their lens axes and two (111)-lenses rotated relative to each other about their lens axes.

In accordance with the invention the aim of the above-described ‘subdivision’ is to provide that, upon the attainment of the same overall thickness for the optical element, or the group formed from the individual lenses, the individual, mutually rotated lenses in the lens groups are each of a smaller thickness or involve lesser birefringence, in particular for example half the maximum thickness (with the same material) or half the birefringence.

In accordance with the invention that achieves a further reduction in the ‘residual error’, which is still present when forming only one lens group (for example in accordance with the lens group 10), in terms of compensating for the retardation of the overall arrangement. In that case the invention makes use of the fact in particular that, as a consequence of an existing non-linear relationship between the maximum retardation on the one hand and the value of the birefringence on the other hand, the above successive connection of a plurality of groups (or ‘subdivision’ of an individual group) makes it possible to achieve a correspondingly overproportional reduction, as will be described in greater detail hereinafter.

It will be appreciated that the invention is not limited to any specific geometry of the illustrated lenses 11-14, 21-24, . . . or lens groups 10, 20, . . . , which basically can be of any cross-section and of any curvature, and in particular can also be of a plate-shaped or cuboidal configuration. In addition the individual lenses 11-14, 21-24, . . . can be selectively isolated in the optical system and arranged with or without a spacing from each other or can also be combined to afford one or more elements (for example by being seamlessly joined together or ‘brought together’).

The invention is further not limited to the rotary angles of 45° (for (100)-lenses) and 60° for (111)-lenses), which are only specified by way of example. Rather, those lens arrangements within the lens groups 10, 20, . . . are also to be deemed to be embraced by the invention, in which the respective identically oriented lenses of a subgroup are rotated relative to each other about their longitudinal axes through a different rotary angle so that a retardation distribution which is reduced in respect of the maximum values is achieved overall within the subgroup.

The invention is further not restricted to the precise number of a total of four lenses (in particular two (111)-lenses and two (100)-lenses) within each lens group 10, 20, . . . . Rather, those lens arrangements within the lens groups 10, 20, . . . are also to be deemed to be embraced by the invention, in which there are more than two (111)-lenses and/or more than two (100)-lenses within each lens group 10, 20.

The lenses 11-14, 21-24, . . . or lens groups 10, 20, . . . can be made from the same, intrinsically birefringent material or also from different, intrinsically birefringent materials.

In IDB compensation by clocking a (100)-pair is combined with a (111)-pair in order to minimise the total retardation. In the case of plane parallel plates of (100)-material and (111)-material, preferably the thickness ratio as follows is satisfied for same with the same angular loading (without the invention being restricted thereto):

$$\frac{{D}_{001}}{{D}_{111}} = \frac{2}{3}$$

In addition the (100)-lenses and (111)-lenses or plates can be of the same or also different maximum thicknesses relative to each other. Preferably however the lenses i, j of each two lens groups (for example the lens groups 10 and 20) are in pairs of such maximum thicknesses that the condition Δnᵢ*Dᵢ=Δnⱼ*Dⱼ is satisfied for each two lenses from different lens groups, if the intrinsic birefringence of the material of the lenses i, j is Δnᵢ and Δnⱼ respectively. When using the same materials therefore preferably the (100)-lens of a lens group is of the same maximum thickness as a (100)-lens of another lens group as in that case (with equality in respect of the respective values Δn*D) the maximum reduction in the ‘residual error’ in retardation is achieved.

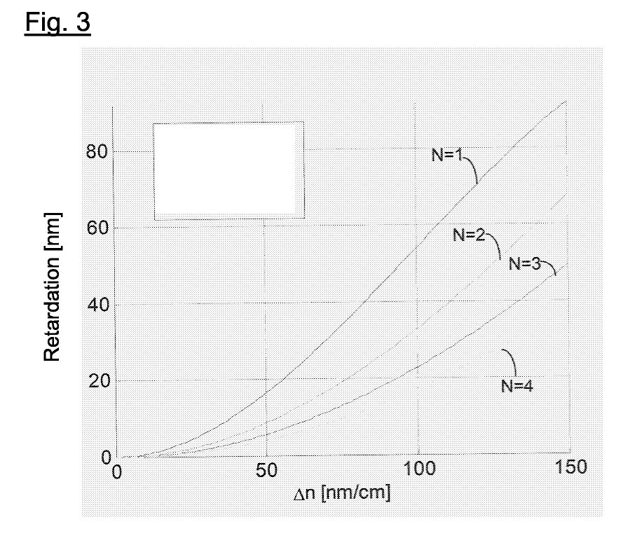

FIG. 3 plots the retardation as a function of birefringence for increasing subdivision of the lenses or plates. For N=1-4 (that is to say for example one to four lens groups, like the lens groups 30 to 60 in FIG. 2 in which N=4), that gives the maximum retardations shown in FIG. 3, in dependence on Δn. It was assumed in that respect that all lens groups are identically oriented relative to each other, that is to say the retardation of the individual combinations is linearly superimposed. For a birefringence Δn of 100 nm the values of the maximum retardation are reduced from 52 nm to 33 nm for N=2, 22 nm for N=3 and 18 nm for N=4.

The above-described reduction in the ‘residual error’ in the retardation, which is achieved by the arrangements according to the invention, is applied in accordance with the present invention in particular to lenses or lens groups which are made from a material with a high intrinsic birefringence as it is precisely in relation to such systems that the ‘residual error’ (this is used to mean the residual retardation caused by the ellipticity of the eigenpolarizations without the subdivision according to the invention into a plurality of ‘successively connected’ groups) assumes high values, as is directly apparent from FIG. 3 by reference to the curve shown for N=1.

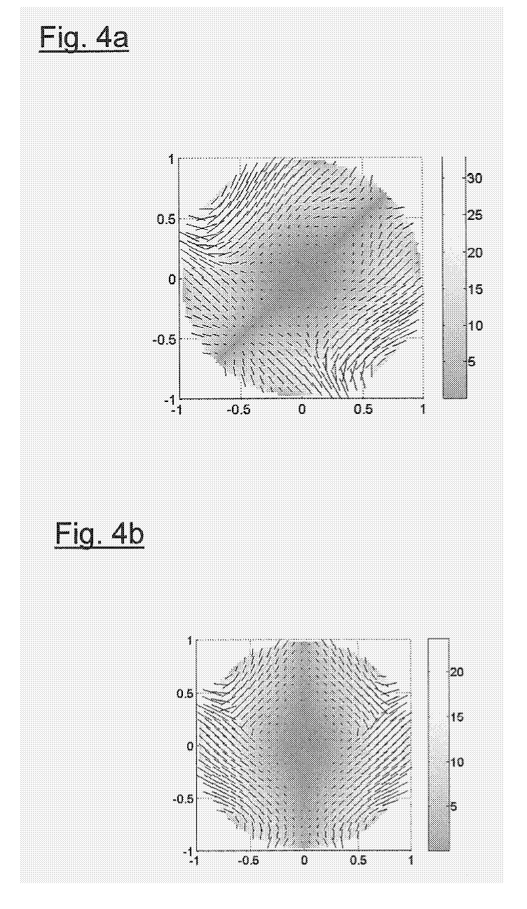

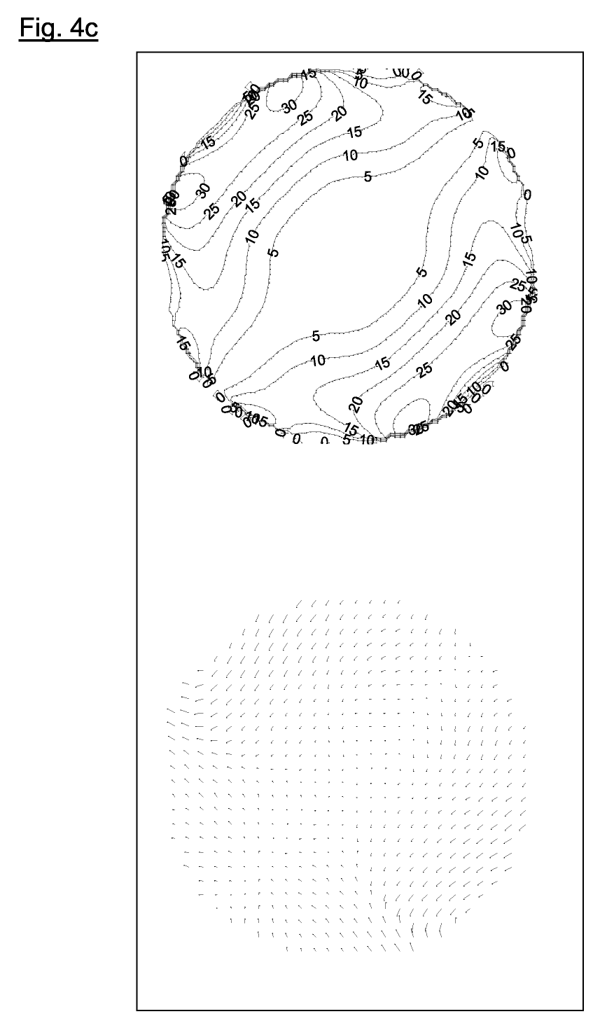

As can be seen from FIG. 4 it is possible to achieve a further marked reduction in maximum retardation by an arrangement which is rotated about the lens axes or ‘superimposition’ of for example two (N=2) or more lens groups. In that respect FIG. 4a specifies the distribution for a succession of identically oriented ‘fours’ groups while FIG. 4b specifies the distribution for a succession of ‘fours’ groups which are rotated relative to each other through 90° about the lens axes. FIG. 4c shows in an additional, alternate illustration of FIG. 4a for the case of identically oriented groups the distribution of the absolute value of retardation (in units of nm, upper part of FIG. 4c) as well as the direction of the fast axis (lower part of FIG. 4c).

In addition, in the embodiments illustrated only by way of example in FIG. 1 and FIG. 2, in the individual lens groups 10-60 the (100)-lenses and the (111)-lenses of a lens group 10-60 are respectively arranged in alternate relationship with each other, that is to say so-to-speak in a ‘permutated arrangement’. The invention however is not restricted to such a permutated arrangement. Rather, those lens arrangements within the lens groups 10-60 are also deemed to be embraced by the invention, in which the (100)-lenses and the (111)-lenses of a lens group 10-60, . . . are respectively not arranged in mutually alternate relationship, that is to say for example at least two lenses of the same orientation are arranged in succession.

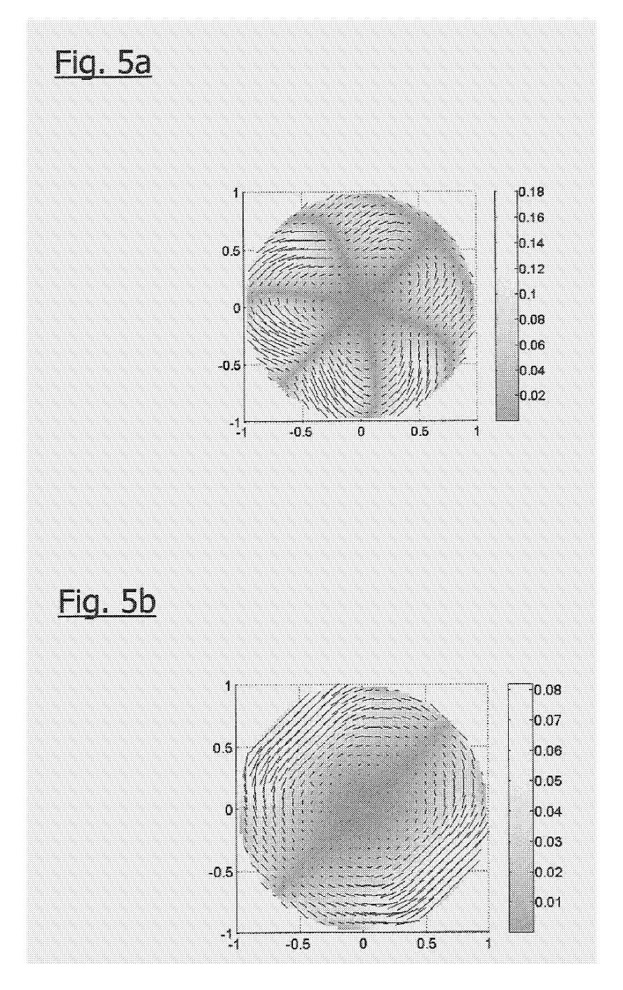

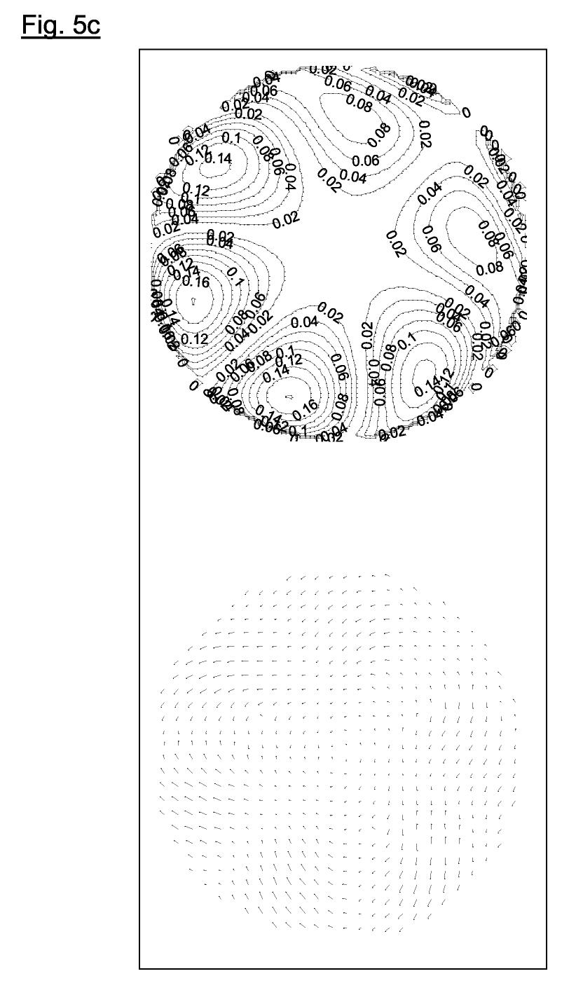

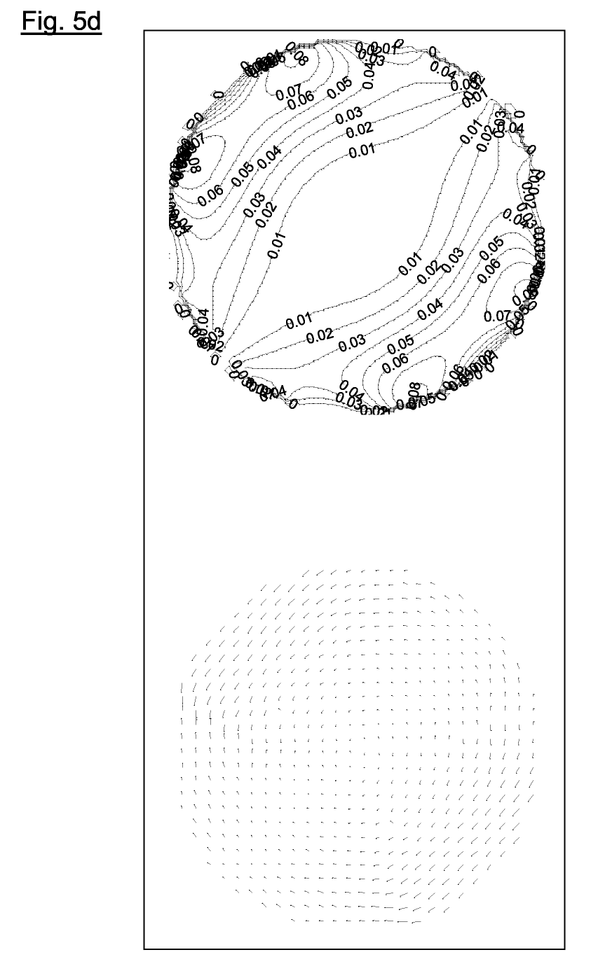

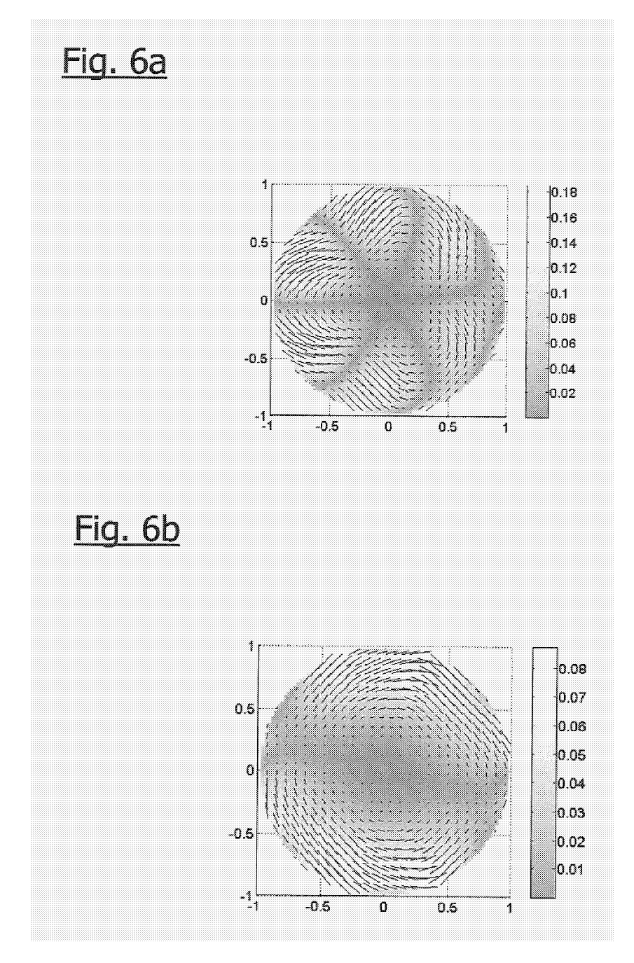

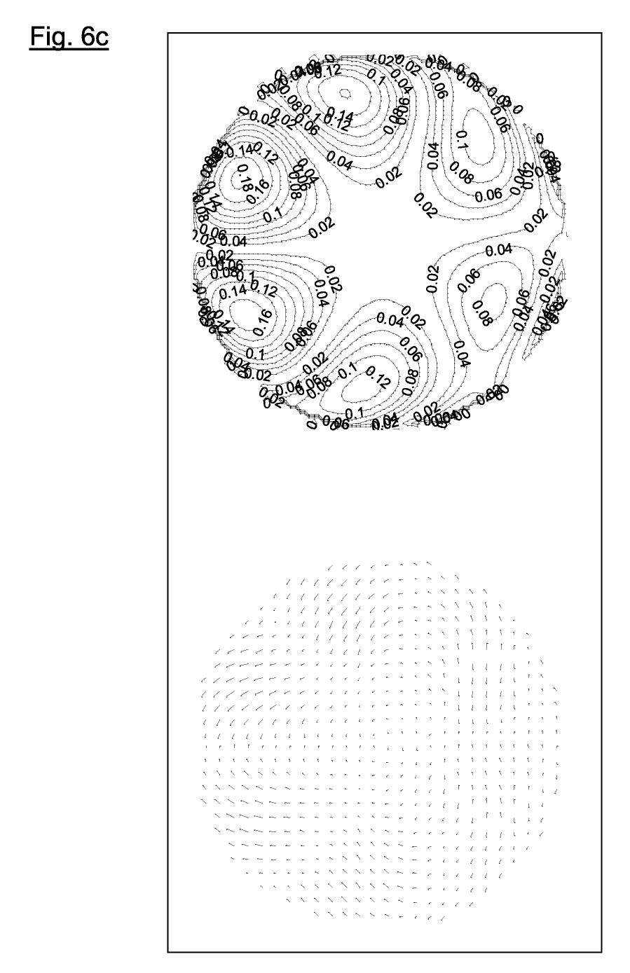

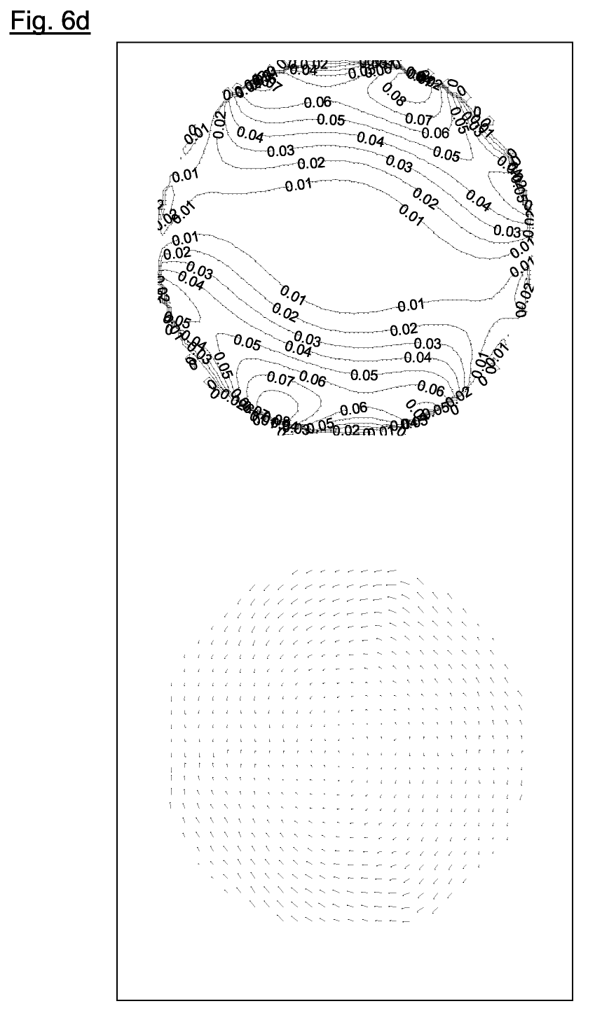

The alternate or permutated arrangement for example as shown in FIG. 1 and FIG. 2 is however advantageous insofar as that provides a relatively more homogeneous configuration and a smaller retardation (smaller for example by approximately a factor of 2), as will be clearly apparent by means of a comparison of corresponding plottings shown in FIGS. 5a-b (for a lens group involving the sequence (111)-(111)-(100)-(100), that is to say in a non-permutated arrangement), or FIGS. 6a-b (for a lens group involving the sequence (111)-(100)-(111)-(100), that is to say in a permutated arrangement). FIG. 5c shows in an additional, alternate illustration of FIG. 5a the distribution of the absolute value of retardation (in units of nm, upper part of FIG. 5c) as well as the direction of the fast axis (lower part of FIG. 5c). FIG. 5d shows in an additional, alternate illustration of FIG. 5b the distribution of the absolute value of retardation (in units of nm, upper part of FIG. 5d) as well as the direction of the fast axis (lower part of FIG. 5d). Furthermore, FIG. 6c shows in an additional, alternate illustration of FIG. 6a the distribution of the absolute value of retardation (in units of nm, upper part of FIG. 6c) as well as the direction of the fast axis (lower part of FIG. 6c). FIG. 6d shows in an additional, alternate illustration of FIG. 6b the distribution of the absolute value of retardation (in units of nm, upper part of FIG. 6d) as well as the direction of the fast axis (lower part of FIG. 6d).

The non-permutated arrangement (referred to hereinafter as ‘Type 1’) is afforded for example for an arrangement corresponding to [111, 111, 100, 100] and is shown in FIG. 5a for the orientation angles [60°, 0°, 45°, 0°]; in FIG. 6a it is shown for the orientation angles [80°, 20°, 45°, 0°], that is to say for a relative rotation of the first homogeneous group (of (111)-lenses) in relation to the second homogeneous group (of (100)-lenses) through 20°. The thicknesses of the lenses in FIG. 5a and FIG. 6a are as follows in the sequence of the lenses: 10 mm, 10 mm, 6.66 mm and 6.66 mm. The material refractive index was assumed to be 1.85 and the NA 1.5. Accordingly the maximum angle in the material is 54.2°.

The permutated arrangement (referred to hereinafter as ‘Type 2’) is afforded for example for an arrangement corresponding to [111, 100, 111, 100] and is shown in FIG. 5b for the orientation angles [60°, 45°, 0°, 0°]; in FIG. 6b it is shown for the orientation angles [80°, 45°, 20°, 0°], that is to say for a relative rotation of the first homogeneous group (of (111)-lenses) in relation to the second homogeneous group (of (100)-lenses) through 20°. The thicknesses of the lenses in FIG. 5b and FIG. 6b are as follows in the sequence of the lenses: 10 mm, 6.66 mm, 10 mm, 6.66 mm, corresponding therefore to an overall thickness for the arrangement of 33.32 mm. The material refractive index was also assumed to be 1.85 and the NA 1.5. Accordingly the maximum angle in the material is 54.2°.

A comparison of the distributions shown in FIGS. 5a,b with those shown in FIGS. 6a,b shows that the distributions of FIGS. 6a,b (Type 2) are of a somewhat more homogeneous configuration and involve a retardation which is less approximately by a factor of 2 than the distributions shown in FIGS. 5a,b (Type 1), wherein Type 2 by definition occurs for combinations in which two identical cuts do not occur in succession. Accordingly it is advantageous for the crystal cuts in the system to be ‘mixed’ as much as possible in terms of their sequence. In other words: an improvement in compensation can be achieved by permutation of the plate sequence.

A rough explanation of the improvement which is further achieved in accordance with the invention in the reduction in retardation by permutation in the lens sequence is set forth hereinafter. Investigations on the part of the inventors have shown that the distribution of intrinsic birefringence is invariant in relation to a pair interchange as the eigenvalues of a matrix product are invariant in relation to an interchange of the matrices. It will be noted however that the eigenvectors change. Purely in combinational terms therefore there are 6 classes each of 4 combinations, for the 4-lens combination. Within a class the elements go through a pair interchange. The investigations carried out by the inventors further showed that those 6 classes however only lead to 2 different types of retardation distributions (namely Type 1 and Type 2), wherein Type 2 occurs by definition for combinations in which two identical cuts do not occur in succession. One reason for this could be an effect equivalent to ‘adiabatic polarisation rotation’ in twisted-nematic LCDs (there observation shows that, in a system with a continuous change in the orientation of the birefringence axis (that is to say for example rotation from 0 to 90° in a TN-LCD) linearly polarised light follows the rotation of the main axis, presuming rotation takes place slowly in relation to the wavelength). Preferably therefore, for IDB compensation of intrinsic birefringence, which is as optimum as possible, the main axes are to be arranged as far as possible in the lens groups in such a way that they do not involve continuous rotation (as two directly successive lenses in the same crystal cut but rotated represent an ‘unfavourable main axis arrangement’ in the foregoing sense).

As already stated, in the successive connection of a plurality of groups (or ‘subdivision’ of individual groups), which is implemented in the embodiments of FIG. 1 and FIG. 2, the invention makes use in particular of the fact that as a consequence of an existing non-linear relationship between the maximum retardation on the one hand and the value of the birefringence on the other hand, it is possible to achieve a correspondingly overproportional reduction. That is described in greater detail hereinafter.

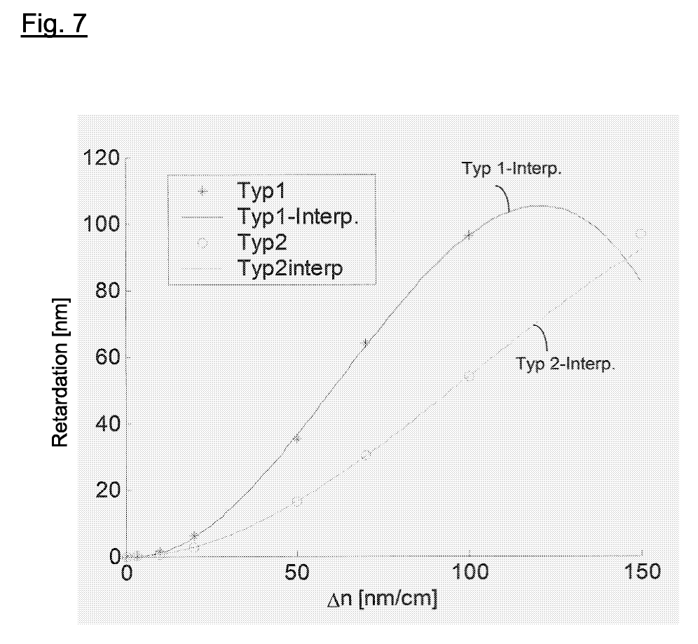

FIG. 7 shows for a lens group (for example the lens group 10 in FIG. 1) the dependency of retardation (in units of nm) on birefringence An (in units of nm/cm), as well as cubic interpolation of the values obtained. The respective values were ascertained for a lens group comprising four lenses in the sequence (111)-(111)-(100)-(100) of thicknesses (in the sequence of the lenses) of 10 mm, 10 mm, 6.6 mm, 6.6 mm, that is to say for a total thickness for the lens group of 33.2 mm. It should be pointed out that here it was assumed that there was a constant thickness for the plate or lens combination. As, as can be seen from the equations (1) and (2) hereinafter, the determining parameter for the maximum retardation resulting from intrinsic birefringence is the value Δn*d, the dependency of the retardation (in units of nm) on the maximum lens or plate thickness is of the configuration corresponding to the plotting in FIG. 7. The corresponding values are set out in Table 1 hereinafter.

TABLE 1

| Δn nm/cm | 3.4 | 10 | 20 | 50 | 70 | 100 | 150 |
|---|---|---|---|---|---|---|---|
| Max. Type 1 | 0.18 | 1.6 | 6.1 | 35.3 | 63.9 | 96.2 | |
| retardation nm | | | | | | | |
| Max. Type 2 | 0.08 | 0.7 | 2.8 | 16.4 | 30.2 | 54.0 | 96.6 |
| retardation nm | | | | | | | |

To a good approximation that affords a cubic configuration corresponding to the following equations:

$$\begin{matrix}Type 1 \text{:} \\ {IDB}_{max} ( {d}_{0} Δ n ) = - {( \frac{{d}_{0} Δ n}{19.7 nm} )}^{3} + {( \frac{{d}_{0} Δ n}{6.4 nm} )}^{2} - \frac{{d}_{0} Δ n}{5.9 nm} & ( 1 ) \\ Type 2 \text{:} \\ {IDB}_{max} ( {d}_{0} Δ n ) = - {( \frac{{d}_{0} Δ n}{33.1 nm} )}^{3} + {( \frac{{d}_{0} Δ n}{10.9 nm} )}^{2} - \frac{{d}_{0} Δ n}{52 nm} & ( 2 )\end{matrix}$$

For low levels of birefringence the configuration is quadratic to a good approximation. With increasing birefringence it is necessary to take account of the linear and cubic term. In regard to the meaning of the designations Type 1 and Type 2 attention is directed to the foregoing description relating to FIGS. 5 and 6. In the case of Type 1 the data are valid only up to Δn=100 nm as there the retardation already reaches λ/2.

Thus in accordance with the invention the non-linear dependency of the maximum retardation on birefringence makes it possible to achieve a correspondingly overproportional reduction due to the subdivision into a plurality of lens groups.

Upon the replacement of an ‘element’ or a lens group comprising four individual lenses like the lens group 10 in FIG. 1 by N ‘elements’ or N lens groups (that is to say for example two lens groups comprising four individual lenses like the lens groups 10 and 20 in FIG. 1 in which therefore N=2), the cumulative thickness of which is equal to the thickness of the original element, that gives:

$${IDB}_{total} = N \cdot {IDB}_{max} ( \frac{{d}_{0} Δ n}{N} ) \qquad ( 3 )$$

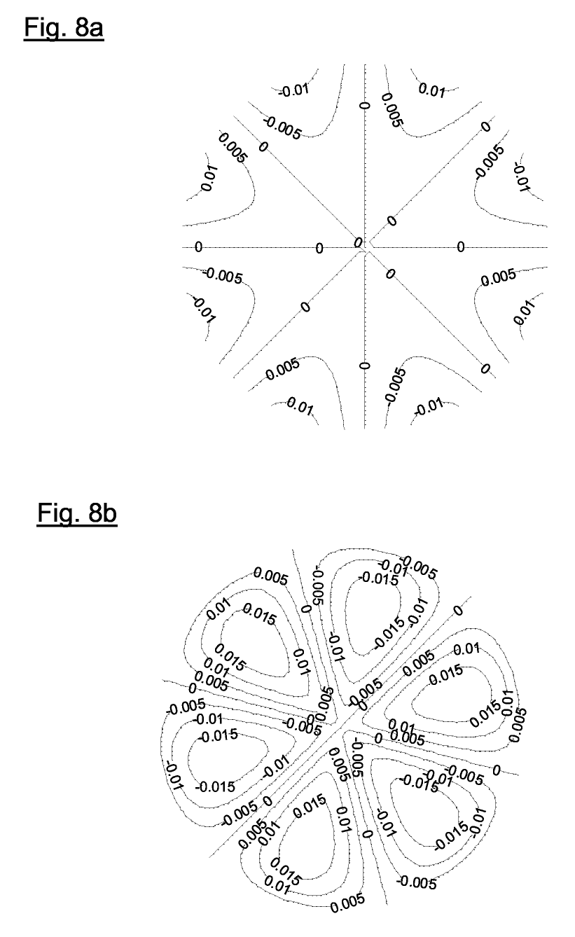

Reference is made hereinafter to FIG. 8 to roughly explain the ‘residual error’ which remains in spite of the reduction in retardation by clocking. In that respect the invention is based on the realisation that the homogenous groups themselves, which are formed by rotation of lenses of the same cut, are admittedly homogeneous in terms of retardation distribution (that is to say they are azimuthally symmetrical), they are not so however in the ellipticity of the eigenpolarizations.

FIG. 8 shows the ellipticity of the eigenpolarizations of homogenised lens pairs in the 100-cut (FIG. 8a) and in the 111-cut (FIG. 8b) respectively. The homogeneous groups of crystal in the (100)-cut at 0° and 45° and in the (111)-cut at 0° and 60° respectively admittedly involve perfect azimuthal symmetry for the magnitude of the retardation and the direction of the large main axis, but not for the ellipticity of the eigenpolarizations, as investigations conducted by the inventors have shown. The main axes of the retardation distribution in the Jones pupil are not perfectly coincident for the rotated cuts but include an angle, the magnitude of which varies over the azimuth. Upon the superimposition of retarding Jones matrices with rotated linear inherent polarisation effects however the overall matrix generally no longer has any linear inherent polarisation effects, but elliptical ones. Two lambda/2 plates which include an angle of 45° act for example as a rotator and therefore have circular inherent polarisation effects. As a respective fourfold or threefold distribution is respectively afforded for the homogeneous groups of (100)-material and (111)-material, symmetry reasons already mean that perfect compensation cannot occur.

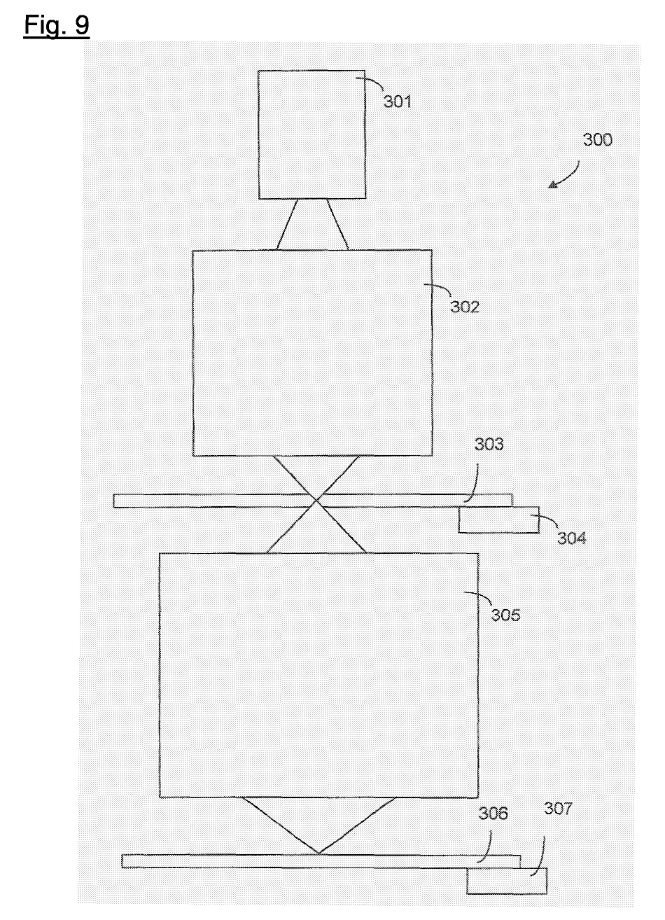

FIG. 9 shows a diagrammatic view of the structure in principle of a microlithographic projection exposure apparatus with an illumination system and a projection objective, in which one or more lenses or lens arrangements according to the invention can be in particular used.

Referring to FIG. 9 a microlithographic projection exposure apparatus 300 comprises a light source 301, an illumination system 302, a mask (reticle) 303, a mask carrier unit 304, a projection objective 305, a substrate 306 having light-sensitive structures and a substrate carrier unit 307. FIG. 9 diagrammatically shows between those components the configuration of two light rays delimiting a light ray beam from the light source 301 to the substrate 306. Lenses with a high refractive index can also be advantageously used in the illumination system, in which case here too intrinsic birefringence has to be compensated.

In this case the image of the mask 303 which is illuminated by means of the illumination system 302 is projected by means of the projection objective 305 on to the substrate 306 (for example a silicon wafer) which is coated with a light-sensitive layer (photoresist) and which is arranged in the image plane of the projection objective 305 in order to transfer the mask structure on to the light-sensitive coating on the substrate 306.

The above description of preferred embodiments has been given by way of example. A person skilled in the art will, however, not only understand the present invention and its advantages, but will also find suitable modifications thereof. Therefore, the present invention is intended to cover all such changes and modifications as far as falling within the spirit and scope of the invention as defined in the appended claims and the equivalents thereof.

1. An optical system having an optical axis, the optical system comprising:
at least two lens groups with lenses made of intrinsically birefringent material and being arranged in the optical system in succession and in mutually adjacent relationship along the optical axis,
wherein:
the lens groups respectively comprise a first subgroup with lenses in a (100)-orientation and a second subgroup with lenses in (111)-orientation,
the lenses of each subgroup are arranged rotated relative to each other about their lens axes,
the (100)-lenses and the (111)-lenses of each lens group are arranged in alternate relationship, and
the optical system is a microlithographic optical system.

2. An optical system according to claim 1, wherein the lenses of each subgroup are rotated relative to each other about their lens axes in such a way that each subgroup has an azimuthally symmetrical distribution of the retardation for two mutually perpendicular polarisation states.

3. An optical system according to claim 1, wherein the lenses of each subgroup are rotated relative to each other about their lens axes in such a way that each subgroup has substantially reduced values of the retardation in comparison with a non-rotated arrangement of the lenses.

4. An optical system according to claim 1, wherein the first subgroup has two (100)-lenses which are arranged rotated relative to each other about their lens axes through 45°+k*90° and the second subgroup has two (111)-lenses arranged rotated relative to each other about their lens axes through 60°+1*120°, wherein k and l are integers.

5. (canceled)

6. An optical system according to claim 1, wherein the lenses of one of the subgroups are arranged rotated about their lens axes relative to the lenses of another of the lens groups.

7. An optical system according to claim 1, wherein lenses of a subgroup of a lens group are respectively of a maximum thickness Dᵢ and are made from a material with an intrinsic birefringence Δni and lenses of a subgroup of another lens group are of a maximum thickness Dⱼ and are made from a material with an intrinsic birefringence Δnⱼ so that the condition Δnᵢ*Dᵢ=Δnⱼ*Dⱼ is fulfilled in pairs for two respective lenses, and wherein i is an integer and j is an integer.

8. An optical system according to claim 7, wherein the condition Dᵢ, Dⱼ≦30 mm is fulfilled for the maximum thicknesses Dᵢ and Dⱼ.

9. An optical system according to claim 1, wherein the number of lens groups is at least three.

10. An optical system according to claim 1, wherein the number of lens groups is at least four.

11. An optical system according to claim 1, wherein the intrinsic birefringence of the material of at least one of the lenses is at least Δn=50 nm/cm.

12. An optical system according to claim 1, wherein the lenses at least partially comprise a crystal material of a cubic crystal structure.

13. An optical system according to claim 1, wherein the optical system comprises at least one lens of a crystal material selected from the group consisting of MgAI₂O₄, MgO and garnets.

14. An optical system according to claim 1, wherein the optical system comprises at least one lens of a crystal material selected from the group consisting of NaCl, KCl, KI, NaI, RbI and CsI.

15. An optical system according to claim 1, wherein the optical system has an image-side numerical aperture (NA) of at least 0.8.

16. An optical system according to claim 1, wherein the resulting maximum retardation of a beam with a working wavelength λ is less than λ/10.

17. An optical system, comprising:
at least one lens of a crystal comprising a material selected from the group consisting of MgAI₂O₄, MgO and garnets,
wherein at least two elements of the crystal material have the same crystal cut and are arranged rotated relative to each other about the lens axis, and/or there are two different crystal cuts of the crystal material, and wherein the optical system is a microlithographic optical system.

18. An optical system, comprising:
at least one lens of a crystal material selected from the group consisting of NaCl, KCl, KI, NaI, RbI and CsI,
wherein at least two elements of the crystal material have the same crystal cut and are arranged rotated relative to each other about the lens axis, and/or there are two different crystal cuts of the crystal material, and wherein the optical system is a microlithographic optical system.

19. An optical system according to claim 17 wherein the two elements are wringed together so that they jointly form a lens.

20. An optical system according to claim 17, wherein the two elements form two separate lenses.

21. An optical system according to claim 17, wherein the combination of the two elements affords an azimuthally symmetrical distribution of the retardation for two mutually perpendicular polarisation states.

22. An optical system according to claim 17, wherein the combination of the two elements leads to a substantial reduction in the values of the retardation in comparison with a non-rotated arrangement or in comparison with the situation where there are only elements of the crystal material in the same crystal cut.

23. An optical system according to claim 17, wherein the maximum beam angle occurring relative to the optical axis in the lens of the crystal material is not less than 25°.

24-26. (canceled)

27. An optical system according to claim 1, wherein a working wavelength of the optical system is less than 250 nm.

28. A microlithographic projection exposure apparatus comprising an objective according to claim 1.

29. A microlithographic projection exposure apparatus comprising an illumination system according to claim 1.
